(19) United States
(12) Patent Application Publication
(10) Pub. No.: US 2003/0105775 A1
(43) Pub. Date: Jun. 5, 2003

(54) Plant management system

(75) Inventor: Toyoharu Shimada, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: MITSUBISHI DENKI KABUSHIKI KAISHA, Tokyo (JP)

(21) Appl. No.: 10/131,220

(22) Filed: Apr. 25, 2002

(30) Foreign Application Priority Data
Nov. 30, 2001 (JP) 2001-366916

(51) Int. Cl. G06F 7/00

(52) U.S. Cl. 707/104.1

(57) ABSTRACT

A plant management system including a terminal device provided in each factory, a server connected to the terminal device through a network, and a data base connected to the server. The server provides, to the terminal device, storage of information to the data base and reading of the information of the data base. Information about each plant of each factory and a history of movement of the plant and a history of maintenance are stored in the data base. It is possible to unitarily manage the location, movement and maintenance histories of the plant. Moreover, it is possible to unitarily manage parts for maintenance of the plant together. Furthermore, it is possible to implement a worldwide plant management at a minimum cost by utilizing the internet and the WWW browser.

### BACKGROUND OF THE INVENTION

The present invention relates to a plant management system in a manufacturing factory. In this specification, “plant” indicates all of equipment, tools and instruments which are installed in a factory and are used for a production activity, for example, equipment and apparatuses such as a manufacturing apparatus, a checking apparatus, measuring apparatuses and equipment for delivery; tools and jigs; computers; and various instruments; and furthermore, indicates parts for maintenance and integrity for the equipment, tools and instruments.

More manufacturing apparatus, checking apparatuses and measuring apparatuses have been used for a production activity in a factory with an improvement in a technology and a combination and integration of products in recent years. Accordingly, it is very important that a plant management for managing the locations and working situations of a large number of devices and apparatuses (hereinafter referred to as “plant”) and for managing maintenance and integrity is to be carried out in order to effectively use the possessed plant. In a factory for manufacturing a semiconductor product in which a large number of expensive plants are introduced and the place of installation of the plants are often moved according to the tendency of a market or a change in a technology, particularly, the degree of importance of the plant management is high.

Certain expensive plants have conventionally been registered and managed as assets. However, the registration and management for the assets is intended for an accounting process such as calculation of depreciation and the management of the situations for approximately half or quarter terms is enough. Therefore, an immediacy is poor. Accordingly, the registration and management cannot be applied to such an object to manage and grasp the frequent movement of the plants and to effectively utilize the plants.

Moreover, Japanese Unexamined Patent Publication Nos. 162057/1998 and 203352/1999 have disclosed an example in which information about a plant is stored in a data base to be used as reference information for preservation management, and maintenance and integrity. In the management system disclosed in these conventional arts, however, the movement of the plant is not considered at all. In modern manufacturing factories in which the transfer and lending of the plant can be carried out between factories developed worldwide inside and outside the country and to cooperative companies or between the cooperative companies, accordingly, it is impossible to apply the management system according to the conventional art.

### SUMMARY OF THE INVENTION

The present invention provides a plant management system capable of grasping and managing the situations of a plant in real time including the movement of the plant between factories developed worldwide. Moreover, the present invention provides a plant management system capable of reliably grasping the movement of the plant and the execution of maintenance and integrity. Furthermore, the present invention provides a plant management system capable of simultaneously managing parts for repairing the plant.

That is, the present invention provides a plant management system including a terminal device provided in each factory, a server connected to the terminal device through a network, and a data base connected to the server. The server provides, to the terminal device, storage of information to the data base and reading of the information of the data base. Information about each plant of each factory and a history of movement of the plant and a history of maintenance are stored in the data base.

Moreover, the present invention provides a plan management system including a server connected to a terminal device in each factory through a network and a data base connected to the server. The server includes plant registering means for storing, in the data base, information about a plant inputted from the terminal device, part registering means for storing, in the data base, information about a part inputted from the terminal device, plant movement managing means for storing, in the data base, information about movement of the plant inputted from the terminal device, maintenance history managing means for storing, in the data base, information about execution of a maintenance work of the plant which is inputted from the terminal device, maintenance planning means for storing, in the data base, a maintenance plan of the plant which is inputted from the terminal device, plant structure registering means for storing a relationship between the plant and a component of the plant which are inputted from the terminal device, part stock managing means for storing, in the data base, information about receipt and discharge of the part inputted from the terminal device, master managing means for changing each master of the data base from the terminal device, term managing means for extracting from the maintenance plan a maintenance plan in which the number of days to an execution date is equal to or less than a predetermined term, mail notifying means for transmitting a guidance mail for maintenance execution to an object plant management department of the extracted maintenance plan, and retrieval reading means for retrieving information in the data base and presenting the information to be readable to the terminal device.

Moreover, the present invention provides a plant management system including a server connected to the terminal device of each factory through a network and a data base connected to the server. The data base includes a plant information table storing information about a plant, a plant history table storing a movement history of the plant, a maintenance history table storing a history of maintenance of the plant, a maintenance plan table storing a maintenance plan, a plant structure table storing a relationship between the plant and a plant component, a part information table storing a stock situation of a part in each stockroom, an ordering history table storing an ordering history of a part, and a receipt and discharge history table storing a history for receipt and discharge of the part.

In the plant management system of the present invention, even in the case where factories or cooperative companies are developed worldwide and a plant is moved between the factories or cooperative companies developed worldwide, it is possible to unitarily manage the location, movement and maintenance histories of the plant.

### BRIEF DESCRIPTION OF THE DRAWINGS

FIG. 1 is a view showing a plant management system according to the present invention;

FIG. 2 is a block diagram showing functions of a plant management system according to the present invention shown in FIG. 1;

FIG. 3 is an view explaining outline about the functions shown in the block diagram of FIG. 2;

FIG. 4 is an view explaining outline about the functions shown in the block diagram of FIG. 2;

FIG. 5 is a view showing an example of a plant information table of data base in a plant management system according to the present invention;

FIG. 6 is a view showing an example of a plant history table of data base in a plant management system according to the present invention;

FIG. 7 is a view showing an example of a maintenance history table of data base in a plant management system according to the present invention;

FIG. 8 is a view showing an example of a maintenance plan table of data base in a plant management system according to the present invention;

FIG. 9 is a view showing an example of a plant structure table of data base in a plant management system according to the present invention;

FIG. 10 is a view showing an example of a part information table of data base in a plant management system according to the present invention;

FIG. 11 is a view showing an example of an ordering history table of data base in a plant management system according to the present invention;

FIG. 12 is a view showing an example of a receipt and discharge history of data base in a plant management system according to the present invention;

FIG. 13 is a view showing an example of an approval table of data base in a plant management system according to the present invention;

FIG. 14 is a view showing an example of a menu selection screen in a plant management system according to the present invention; and

FIG. 15 is a view showing an example of a plant number tag in a plant management system according to the present invention.

### DETAILED DESCRIPTION

An embodiment of a plant management system according to the invention will be described with reference to the accompanying drawings.

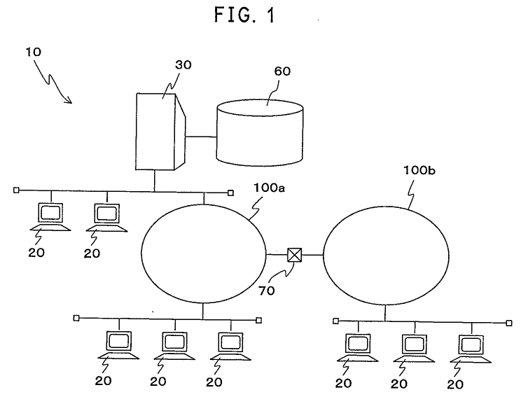

As shown in FIG. 1, a plant management system 10 according to the present invention comprises a terminal device 20 and a server 30 which are connected through a network 100 (100a, 100b), and a data base 60 connected to the server 30. In FIG. 1, numeral 70 denotes a firewall.

The network 100 might be a closed network such as a so-called internal LAN. In the plant management system according to the present invention, however, an internal network 100a and a network 100b of a cooperative company are actually connected by utilizing internet in order to implement plant management including a factory developed worldwide and the cooperative company. In this case, the terminal device 20 includes a WWW (World Wide Web) browser and an electronic mail client, and the server 30 serves as a Web server to provide, to the terminal device 20, an access to a data base 60.

The data base 60 includes a plant information table for storing information about each plant, a plant history table for storing a movement history of each plant, a maintenance history table for storing an integrity and maintenance history of each plant, a maintenance plan table for storing an integrity and maintenance plan of each plant, a plant structure table for storing a component of each plant, a part information table for storing information about each part and the situations of a stock, an ordering history table for storing an ordering history of each part, and a receipt and discharge history table for storing a receipt and discharge history of each part.

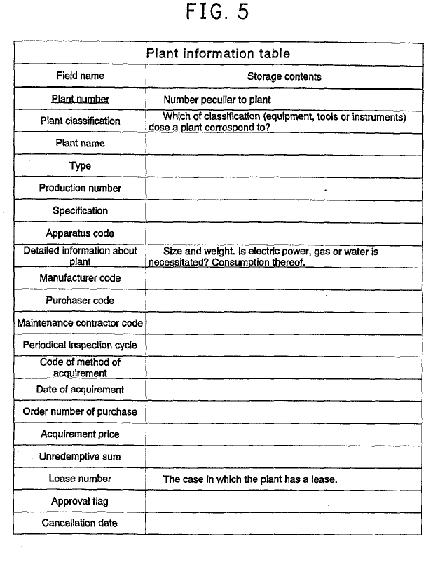

FIGS. 5 to 13 show example 5 of items stored in each table, that is, a field item. In FIGS. 5 to 13, a field name is underlined for a field to be a key.

As shown in FIG. 5, the plant information table stores a plant classification indicative of the kind of the plant, the name and type of the plant, a manufacturing number and specifications by using a plant number peculiar to each plant as a key. Moreover, it is preferable to store detailed information about the plant such as size, weight, an electric power and a gas which are to be used. Furthermore, the plant information table stores a manufacturer and a purchaser of the plant, a maintenance contractor and a periodical inspection cycle. Moreover, there are stored information about the purchase of the plant and depreciation, that is, a method and date of purchase of the plant, an order number and a purchase price at the time of the purchase of the plant, a redemptive sum and an unredemptive sum. Furthermore, in the case where the plant has a lease, a lease number is stored. In order to distinguish a plant which does not need to be managed due to sale or scrap, moreover, a cancellation date field is provided.

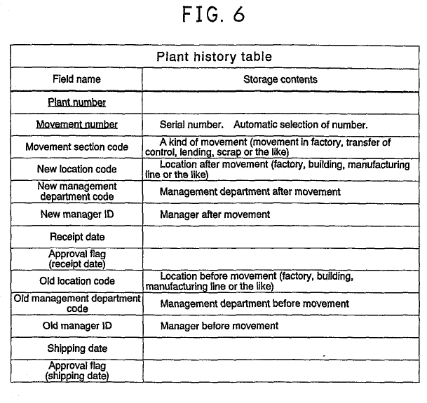

The plant history table stores a past movement history of each plant. As shown in FIG. 6, accordingly, the plant history table stores a movement section code indicative of the kind of a movement, a new location code indicative of a location of the plant, a management department and a manager after the movement, a new management department code and a new manager ID by using, as keys, a plant number of each plant and a movement number to be a serial number. Moreover, the plant history table includes a receipt date field for storing a date of receipt confirmation of the plant by a new manager. Furthermore, it is preferable that the plant history table stores an old location code indicative of a location, a management department and a manager before the movement of a plant, an old management department code and an old manager ID. Moreover, it is preferable that a shipping date field for storing a date of shipping from an old location is provided.

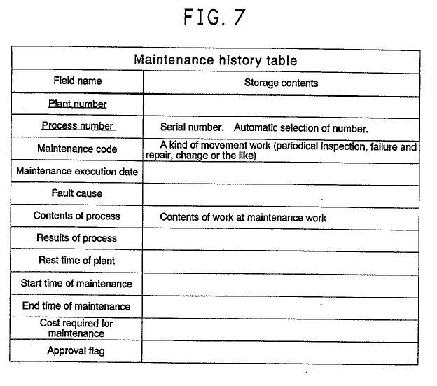

The maintenance history table stores a history of a past maintenance work for each plant. As shown in FIG. 7, accordingly, the maintenance history table stores a maintenance code representing the kind of the executed maintenance work and an execution date of the maintenance by using, as keys, a plant number of each plant and a process number to be a serial number. Furthermore, it is preferable that the contents and results of the process in the maintenance work are stored as the contents and results of a process. Moreover, in the case where the maintenance work is carried out corresponding to a failure, it is preferable that the cause of the failure is stored together. Furthermore, it is preferable that the maintenance history table stores a time and cost required for the maintenance work as a time required for the maintenance and a cost required for the maintenance. In place of the time required for the maintenance, the start and end times of the maintenance work might be stored. Furthermore, the stop time of the plant for the maintenance work might be stored as a plant rest time.

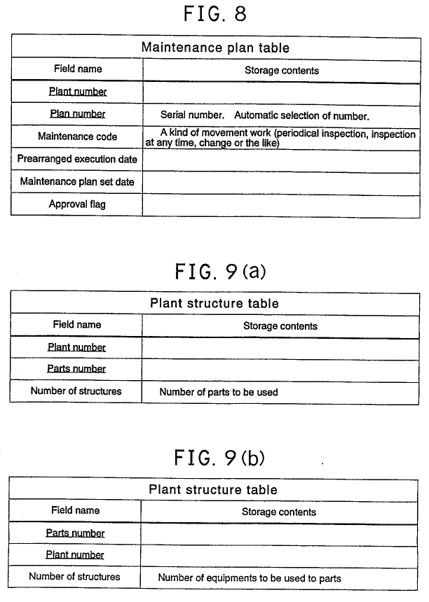

The maintenance plan table stores a plan of a maintenance work for each plant. As shown in FIG. 8, accordingly, the maintenance plan table stores a maintenance code representing the kind of a maintenance work to be executed and a prearranged execution date for the maintenance work by using, as keys, a plant number of each plant and a plan number to be a serial number. Moreover, it is preferable that the predetermined date of a maintenance plan is stored as a maintenance plan set date.

In the plant structure table, a component is listed for each plant. More specifically, as shown in FIG. 9(a), a plant number is stored in a plant number field and a part number of a part used in the plant is stored in a part number field. By using, as keys, the plant number and the part number, the number of parts to be used for one plant is stored in a structure number field.

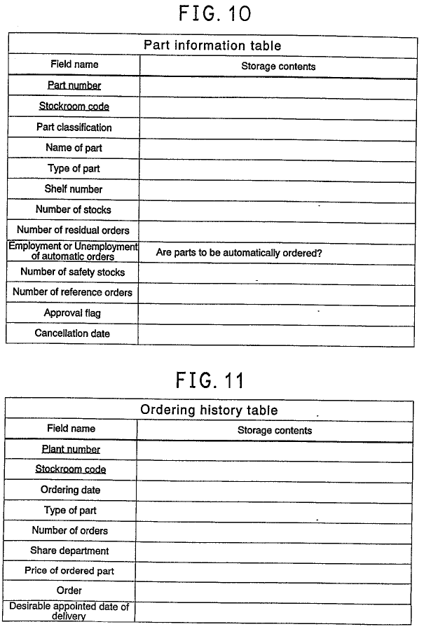

As shown in FIG. 10, the part information table stores a part classification indicative of the kind of a part, the name and type of a part, a shelf number in a stockroom to be a storage destination and the like by using, as keys, a part number of each part and a stockroom code indicative of a stockroom to be a storage destination. Furthermore, the part information table stores the number of stocks of the part and the number of residual orders, the presence of automatic orders, the number of safety stocks and the number of reference orders. In order to leave, as a history, parts which do not need to be managed due to the sale or scrap of the plant, moreover, a cancellation date field is provided.

The ordering history table stores a part ordering history. As shown in FIG. 11, accordingly, the ordering history table stores the number of orders and a desirable appointed date by using, as keys, a stockroom code indicative of a part number and a storage destination and an ordering date. Furthermore, it is preferable to provide an ordering price field for storing the price of an ordered part, a share department code for storing a department code of a part price share department, and an ordering field indicative of an order to pay the price of the part.

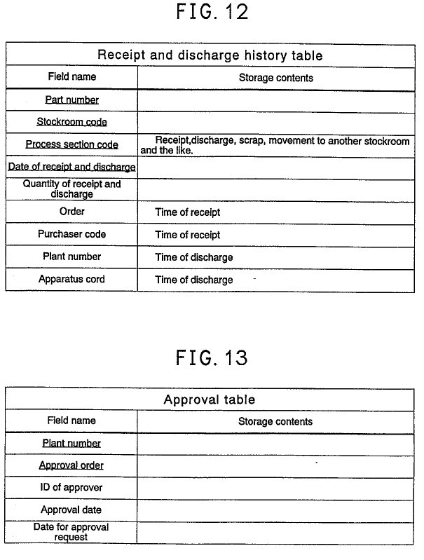

The receipt and discharge history table. stores a receipt and discharge history of a part. More specifically, as shown in FIG. 12, the receipt and discharge history table stores a receipt and discharge quantity indicative of a quantity of receipt/discharge by using, as keys, a part number, a stockroom code indicative of a stockroom to be a storage destination, a process section code indicative of the kind of a receipt and discharge and a receipt and discharge date indicative of a date that the receipt/discharge is carried out. Furthermore, the receipt and discharge history table stores a part order and a purchaser code when the part is received, and stores a plant number to be a discharge destination when the discharge for the part is carried out.

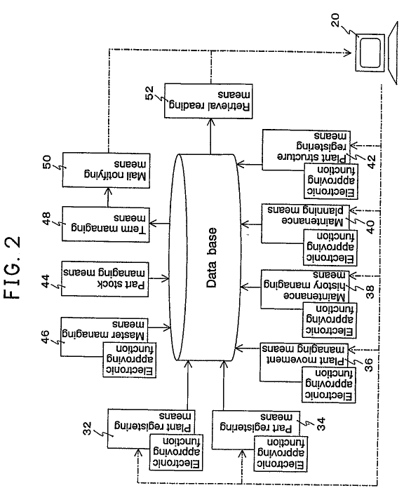

In order to store information in each table of the data base 60 and to utilize the information stored in each table, the server 30 includes each means shown in FIG. 2, that is, plant registering means 32, part registering means 34, plant movement managing means 36, maintenance history managing means 38, maintenance planning means 40, plant structure registering means 42, part stock managing means 44, master managing means 46, term managing means 48, mail notifying means 50 and retrieval reading means 52.

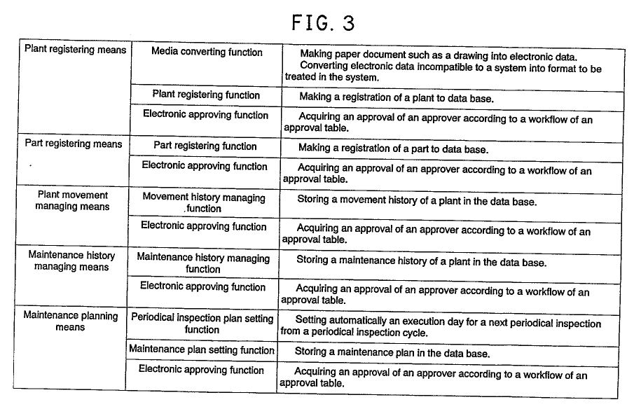

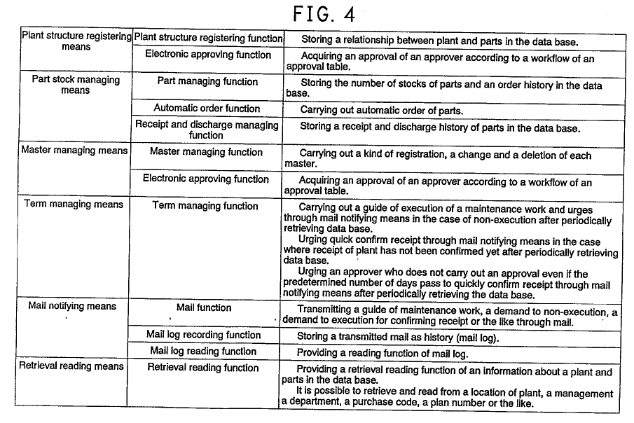

The function and operation of each means will be described below with reference to a function list shown in FIGS. 3 to 4.

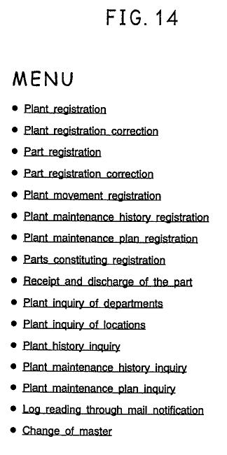

First of all, the function and operation of the plant registering means 32 will be described. A user uses the terminal device 20 and connects the terminal device 20 to the server 30 through the network 100. A menu selection screen shown in FIG. 14 is transmitted from the server 30 and is displayed on a web browser of the terminal device 20. When the user selects, “plant registration” from the displayed menu selection screen, an input screen for plant registration is displayed on the terminal device 20 of the user through the plant registering means 32.

The user uses the input screen to input information about the plant. The input of the user is transmitted to the plant registering means 32 and an inherent plant number is affixed thereto, and the information is stored in the plant information table (see FIG. 5) of the data base 60. Moreover, also in the case where the user selects “plant registration correction” on the menu screen in FIG. 14, an input screen for plant registration correction is displayed on the terminal device 20 of the user through the plant registering means 32. The correction of the plant information by the user is transmitted to the plant registering means 32 and is stored in the plant information table of FIG. 5.

Thus, the display of the menu selection screen and the menu selection of the user can be implemented by a web browser provided in the terminal device 20 of the user and an HTML document in the server 30. Moreover, the storage of the information input by the user in the data base (the plant information table) can be implemented by using, for example, an ASP (Active Server Pages) technique.

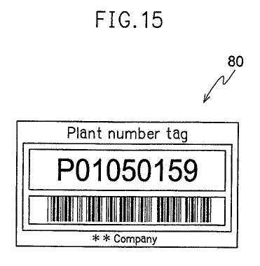

The plant registering means 32 has a bar code output function and serves to convert the plant number of the registered plant into a format which can be read by an optical or electromagnetic method such as a bar code or an ID tag and to output the format thus obtained. FIG. 15 shows an example in which the plant number is outputted as a plant number tag 80 with a bar code. By sticking/attaching the bar code and the ID tag thus outputted to the plant, the plant number can be collated with the actual plant thing easily and reliably. Moreover, the plant registering means 32 has a media converting function, and can convert specifications and instruction manual in paper, and drawing of the plant into such a format to be treated in the plant management system according to the present invention and can store them as electronic data in the plant information table.

Next, the function and operation of the part registering part 34 will be described. The part indicates a part which constitutes a plant and is to be stocked in a factory for the integrity and maintenance of the plant. When the user selects “part registration” from the menu selection screen in FIG. 14, the part registering means 34 displays an input screen for part registration on the terminal device 20 of the user. The user uses the input screen and inputs each field item of the part information table of FIG. 10. The input of the user is transmitted to the part registering means 34 and is stored in the part information table (FIG. 10) of the data base 60.

It is preferable that the input of the user is carried out only once when each part is stored in each stockroom at a first time in principle. A subsequent change in the number of stocks or the number of residual orders is automatically updated by the following part stock managing means 44 by referring to the ordering history table and the receipt and discharge history table.

Next, the function and operation of the plant movement managing means 36 will be described. In some cases, the plant is moved to another manufacturing line or factory after plant introduction. In some cases, moreover, tools or measuring devices are temporarily lent to another manufacturing line or factory. In some cases, furthermore, the plant is not used to be idle or is scrapped. In these cases, the user selects “plant movement registration” from the menu selection screen of FIG. 14. By the plant movement managing means 36, an input screen for registering the movement of the plant is displayed on the terminal device 20 of the user.

A movement source, that is, a user to be the current manager of the plant specifies a plant to input a location after movement (the name of a factory, a building, a manufacturing line or the like), a management department after the movement and a manager after the movement by using the input screen. The input of the user is transmitted to the plant movement managing means 36, and a movement number to be a serial number is affixed and the input is stored in the plant movement history table.

A movement destination of the plant, that is, a user to be a new manager of the plant gives access to the server 30 by using the terminal device 20 upon receipt of the plant. When the user selects “plant movement registration” from the menu selection screen of FIG. 14, an input screen for registering the movement of the plant is displayed on the terminal device 20 of the user by the plant movement managing means 36. When the user inputs a receipt date of the plant, the receipt date is stored in a receipt date field of the plant history table (FIG. 6).

A movement number in the plant movement history table is a serial number to be affixed to each plant (that is, a plant number). Accordingly, the movement of each plant can be managed in time series based on the movement number, and a past movement history and a current location can be grasped accurately.

Referring to a plant to be treated as fixed assets, particularly, actual thing collation is carried out periodically, for example, once a year or every six months. In such a case, a bar code stuck/attached to the plant or an ID tag is read by a reader such as a bar code reader and is transmitted to the server 30 through the network 100, thereby carrying out collation with the data of the plant movement history table. Consequently, it is possible to efficiently confirm, without error, that each plant is placed in a location registered in the plant movement history table.

Next, the function and operation of the maintenance history managing means 38 will be described. In some cases, a fault is caused in the plant so that the plant is repaired. In some cases, moreover, inspection is carried out periodically or at any time. In some cases, furthermore, preventive maintenance is carried out, for example, parts of consumption are exchanged previously. In addition, improvement or reconstruction is carried out to enhance performance or change the uses in some cases. In such a case, the user selects “plant maintenance history registration” from the menu selection screen of FIG. 14. By the maintenance history managing means 38, an input screen for registering the maintenance history of the plant is displayed on the terminal device 20 of the user.

The user inputs information about the maintenance of the plant by using the input screen. The input of the user is transmitted to the maintenance history managing means 38 and is stored in the maintenance history table. As described above with reference to FIG. 7, the maintenance history table stores a plant number, a process number, a maintenance execution date, a maintenance code, a fault cause, the contents of the process, a rest time, a time required for maintenance and the like. In the maintenance history table, the process number is a serial number affixed to each plant. The maintenance history of each plant can be managed in time series based on the process number. On the other hand, the maintenance code represents the kind of a maintenance work. For example, a maintenance work such as receiving check, periodical inspection, preventive repair, sudden repair, improvement or reconstruction is indicated as a code number.

In the present invention, thus, the maintenance history of each plant having the process number affixed thereto is stored in the data base. Therefore, it is possible to accurately grasp the history of a last maintenance work. Accordingly, it is possible to know the kind of a maintenance work and a frequency at which the maintenance work is to be carried out, and it is possible to utilize the maintenance history as a factor for decision in order to make a preventive maintenance plan based on the tendency of the fault, to make proper the stock amount of parts to be repaired and to determine whether or not a plant is to be updated. Moreover, since the rest time of the plant, the time required for the maintenance and the cost to be required are stored, it is easy to find a plant which takes a rest very often and has a low working rate and a non-economical plant in which a cost for maintenance is increased. Thus, the maintenance history is useful for making the preventive maintenance plan, managing the parts to be repaired and determining the necessity of the plant update.

Next, the maintenance planning means 40 will be described. The maintenance planning means 40 calculates a prearranged date for next periodical inspection from the periodical inspection cycle of the plant which is stored in the plant information table in FIG. 5 and stores the same date in the maintenance plan table. Moreover, in the case where the inspection is planned at any time or the plant is planned to improve or reconstruct, the user selects “plant maintenance plan registration” from the menu selection screen of FIG. 14. By the maintenance planning means 40, an input screen for registering the maintenance plan of the plant is displayed on the terminal device 20 of the user. The user inputs the maintenance plan of the plant by using the input screen. The input of the user is transmitted to the maintenance planning means 40 and is stored in the maintenance plan table.

As described above, the maintenance plan table (FIG. 8) stores a plant number, a plan number, a maintenance code, a prearranged execution date, a maintenance plan set date and the like. As a matter of course, another information might be added and stored. In the maintenance plan table, the plan number is a serial number affixed to each plant, and furthermore, the maintenance code represents the kind of a maintenance work. For example, periodical inspection, inspection to be carried out at any time, improvement, reconstruction or the like is represented by the code number.

In the present invention, thus, the maintenance plan of each plant having the plan number affixed thereto is stored in the data base. Therefore, it is possible to precisely grasp the kind of a maintenance to be currently scheduled and a prearranged execution date. Accordingly, a guidance mail indicating that the prearranged execution date of the maintenance is coming is sent in cooperation of the term managing means 48 and the mail notifying means 50 which will be described below, thereby enabling the secure execution of maintenance.

By matching the maintenance plan table with the maintenance history table based on the plant number and the maintenance code, moreover, it is possible to ascertain whether or not the planned maintenance has been executed. Furthermore, if a field for storing the plan number is also provided in the maintenance history table of FIG. 7, it is easier to match the maintenance history table with the maintenance plan table. In the present invention, thus, the maintenance plan table and the maintenance history table are provided so that execution and non-execution of the maintenance plan can be grasped. In the case where the maintenance has not been carried out after the prearranged execution date, a demand mail to urge the execution of the maintenance can be sent to reliably realize the execution of the maintenance by the term managing means 48 and the mail notifying means 50 which will be described below.

Next, the plant structure registering means 42 will be described. The user selects “plant structure registration” from the menu selection screen of FIG. 14. An input screen for registering the structure of a plant, that is, the relationship between the plant and the parts constituting the plant is displayed on the terminal device 20 of the user by the plant structure registering means 42. The user inputs the structure of the plant by using the input screen. More specifically, the user inputs a plant number and a part number of parts used in the plant, and inputs the number of the parts. The input of the user is transmitted to the plant structure registering means 42 and is stored in the plant structure table.

As shown in FIG. 9, a plant number, a part number of parts and the number of structures are stored in the plant structure table. By using the following retrieval reading means 52, accordingly, the user can specify the plant number to read the parts used in the plant. To the contrary, it is possible to read the plant using the parts by specifying the part number. In order to carry out the bi-directional reading operation easily and quickly, it is preferable to prepare a plant structure table in a forward direction in which sorting is carried out by using the plant number as a key as shown in FIG. 9(a) and a plant structure table in a reverse direction in which the sorting is carried out by using the part number as a key as shown in FIG. 9(b).

Next, the function and operation of the part stock managing means 44 will be described. The part stock managing means 44 compares the number of stocks of the part stored in the part information table with the number of safety stocks. If the number of stocks is less than the number of safety stocks, the same part is ordered automatically. It is assumed that the number of orders is set to be a reference number of orders stored in the part information table. Moreover, the part stock managing means 44 stores the part number and stockroom code of the ordered part, an ordering date and the number of orders in the ordering history table simultaneously with the ordering. As shown in FIG. 11, the ordering history table further stores an ordering date, an ordering number and the like. In the case where the part is not automatically ordered, it is preferable that the user inputs information about the ordering from the terminal device 20 to store the same information in the ordering history table.

In the case where the ordered part is received or the part is used, the user selects “part receipt and discharge registration” from the menu selection screen of FIG. 14. By the part stock managing means 44, an input screen for registering the receipt and discharge of the part is displayed on the terminal device 20 of the user. The user inputs the receipt and discharge of the part by using the input screen. More specifically, the user inputs the kind of a stockroom, a part number and the number of parts which have been received. Alternatively, the user inputs the kind of a stockroom, a part number and the number of parts which have been paid out. The input of the user is transmitted to the part stock managing means 44 and is stored in the receipt and discharge table. As shown in FIG. 12, the receipt and discharge history table stores a part number and stockroom code of the part to be an object of receipt and discharge, a process section code representing the king of the receipt and discharge, the date of the receipt and discharge, the quantity of the receipt and the discharge, and the like. The kind of the receipt and discharge includes the receipt of an ordered part, movement to another stockroom, discharge for use in maintenance, sale, scrap and the like.

In the present invention, thus, the ordering history of a part is stored in the ordering history table. Therefore, the ordering situation of each part can be grasped in time series, and the number of safety stocks and the number of reference orders can be set properly. Moreover, the number of stocks and the number of residual orders are reflected by the number of orders and the quantity of receipt and discharge in the ordering history table and the receipt and discharge history table. Consequently, the situations of the stock of each part in each stockroom can be grasped in real time.

Next, the function and operation of the master managing means 46 will be described. As described above, each table of the data base 60 stores information by using a code number or an ID number. Accordingly, the data base 60 requires a location master storing the relationship between a location code and the name of an actual factory, the name of a building and the name of a manufacturing line; a movement section master storing the relationship between the movement section code and the kind of movement; a maintenance code master storing the relationship between a maintenance code and the kind of maintenance; and the like. The master managing means 46 is used for managing these masters.

When the user selects “master change” from the menu selection screen of the FIG. 14, a screen for inputting the change of the master is displayed by the terminal device 20 of the user through the master managing means 46. The user can carry out the change of the master by using the input screen. For the change of the master, it is preferable that authentication such as the input of a password is required to prevent the change of the master from being carried out by a user having no authority.

Next, the functions and operations of the term managing means 48 and the mail notifying means 50 will be described. The term managing means 48 periodically retrieves the data base 60 and compares a prearranged execution date of a maintenance plan in the maintenance plan table of FIG. 8 with the date of that day, for example. Moreover, the execution or non-execution of each maintenance plan is confirmed by referring to the maintenance history table of FIG. 7. In the case where the prearranged execution date of the maintenance plan is coming and the maintenance plan has not been executed or the case where the prearranged execution date passes and the maintenance plan has not been executed, the mail notifying means 50 is used to transmit a mail to urge the execution of the maintenance to a management department or a manager of the plant. For this reason, the data base 60 requires a master storing a mail address of each management department or manager.

Similarly, also in the case where the movement of a plant is registered in the plant history table of FIG. 6 but receipt has not been confirmed, that is, new and old locations, management departments, managers and a shipping date are inputted but a receipt date is not inputted, the term managing means 48 and the mail notifying means 50 urge the new management department or the new manager to confirm the receipt, that is, to input the receipt date through a mail.

According to the present invention, thus, the date stored in each table and the date of that day are utilized to give warning through a mail to the management department or the manager in the plant in which the maintenance work or receipt confirmation has not been executed. Accordingly, it is possible to reliably execute the maintenance plan and to surely manage the location of the plant.

It is preferable that the mail of the mail notifying means 50 is stored as a mail log in the data base 60 to be read from the information terminal 20 through the retrieval reading means 52 which will be described below. It is possible to read the history of a demand through a mail and to intensify the management and guidance for the management department or manager to which the demand is given very often. Thus, the maintenance can be executed and the location of the plant can be managed more reliably.

Next, the function and operation of the retrieval reading means 52 will be described. The retrieval reading means 52 retrieves each table in the data base 60 at the request of the user, and extracts a record coincident with the request of the user and displays the record on the terminal device 20 of the user.

For example, in the case where the user selects “plant inquiry by location” from the menu screen of FIG. 14, the retrieval reading means 52 displays an input screen for specifying a location on the terminal device 20 of the user. The specification of the location by the user is transmitted to the retrieval reading means 52 of the server 30 through the network 100. The retrieval reading means 52 retrieves the plant history table and extracts all plants in which a new location code is coincident with a location inputted by the user. The terminal device 20 of the user is caused to display plant numbers of these plants are displayed as a list of plants in the location specified by the user. It is preferable to retrieve the plant information table based on the extracted plant numbers and to display the name and type of plants and the like on the terminal device of the user together.

Similarly, in the case where the user selects “plant maintenance plan inquiry” from the menu screen of FIG. 14, it is preferable to display an input screen for inputting a plant number on the terminal device 20, to extract, from the maintenance plan table, a record corresponding to the plant number inputted by the user, and to display the same record on the terminal device 20. In place of the input of the plant number by the user, a location code or a purchase order number might be inputted so that a plant coincident with the location code or the purchase order number is displayed as a candidate on the terminal device 20, and the user might select a plant from the candidate for which reference is to be made to a maintenance plan.

It is preferable that the electronic approving function is provided in each means having the function of receiving the input of the user and storing the same input in the data base 60, for example, the plant registering means 32, the part registering means 34, the plan movement managing means 36, the maintenance history managing means 38, the maintenance planning means 40, the plant structure registering means 42, the master managing means 46, and the like.

More specifically, an approval flag field representing the present of approval is provided in each table of the data base 60, and furthermore, an approval table for storing an ID of an approver and an approval order is provided in the data base 60. FIG. 13 shows an example of an approval table. When the user selects “plant registration” from the menu selection screen of FIG. 14 to register a plant, for example, an electronic mail for an approval request is transmitted from the mail notifying means 50 to an approver having a minimum approval order in the approval table. When the approver carries out electronic approval with a connection to the server 30, the date of a day that the approval was carried out is stored in an approval date field of the approval table, and furthermore, an electronic mail for an approval request is transmitted from the mail notifying means 50 to an approver having a next approval order. Thus, when all the approvers in the approval table complete the approval, a flag representing “approved” is written to the approval flag field of the plant information table.

Thus, the approval table describing a work flow for approval is provided in the data base 60 and the approval flag field is provided in each table. Consequently, an approved record can be distinguished from an unapproved record and the unapproved information does not become a reading object. By the term managing means 48 and the mail notifying means 50, a mail for demand might be transmitted to an approver who does not carry out the approval even if a predetermined number of days pass.

While the plant management system according to the present invention has been described with reference to the structure of the data base, the data base in the plant management system according to the present invention is not restricted to the illustrative structure. For example, a person skilled in the art can easily understand that various data base structures can be employed without departing from the scope of the invention, for example, the plant information table is also provided with a field for storing a code of a new location to obtain a quick response during the plant inquiry by a location.

According to the plant management system of the present invention, even in the case where factories or cooperative companies are developed worldwide and a plant is moved between the factories or cooperative companies developed worldwide, it is possible to unitarily manage the location, movement and maintenance histories of the plant. Moreover, it is possible to unitarily manage parts for maintenance of the plant together. Furthermore, it is possible to implement a worldwide plant management at a minimum cost by utilizing the internet and the WWW browser.

In the plant management system according to the present invention, moreover, the information about the movement and maintenance of the plant is reflected in real time. Therefore, it is possible to carry out reliable management without separating the information from the actual situations of the plant. Furthermore, the contents of the movement and maintenance from the purchase of a plant to scrap are stored as a history, and a progress of ordering, receipt and discharge of the part is also stored as a history. Therefore, it is possible to manage a life cycle of a plant to be required by ISO or the like.

Moreover, the approval in various registration processings is acquired electronically in accordance with a work flow stored in the data base. Therefore, it is possible to eliminate papers, thereby rapidly carrying out the approval. Furthermore, in the case where the approval is not carried out even if a predetermined period passes, a demand is automatically sent through a mail so that the approval can be acquired reliably. Similarly, also in the case where the receiving side does not confirm the receipt during the movement of the plant, a demand is sent to a management department or a manager on the receiving side through a mail. Accordingly, the storage contents of the data base can be surely reflected by the movement of the plant. By referring to the data base, moreover, it is possible to grasp the situations of approval at the present time and receipt confirmation and the situations of a demand.

Furthermore, the fact that the execution day of a maintenance plan is coming is guided through a mail. In the case where the maintenance is not carried out even if the execution day passes, a demand is sent by a mail. Therefore, it is possible to reliably execute the maintenance. Moreover, the maintenance plan of periodical inspection is automatically prepared based on a periodical inspection cycle. Also in this respect, similarly, the maintenance can be executed reliably.

Moreover, the price or unredemptive sum of a plant, a lease number and the like are stored as information about the plant. Therefore, it is possible to easily and reliably carry out processing of materials on accounting generated by movement or scrap of the plant. Furthermore, an inherent plant number is given to each plant and is stuck to the plant with a bar code. Therefore, it is possible to easily collate the actual things without error and to prevent a loss of the plant and management omission.

In addition, the number of stocks of each part in each stockroom can be managed in real time, and furthermore, the number of stocks in real time is compared with the number of safety stocks, thereby automatically ordering the part. Therefore, even if the number of stocks of the part is decreased, there is a low possibility that no stock might be caused. Furthermore, the history from the order of the part to the discharge is stored. Consequently, it is possible to grasp the frequency of use and the number of stocks, which can be utilized for deciding the necessity of part registration and selecting the number of safety stocks and the number of reference orders.

Moreover, it is possible to display the number of plants, the price for a purchase, an unredemptive sum and the like for each classification, location or management department of the plant by specifying the classification, the location or the management department of the plant to retrieve the data base. Furthermore, the acquirement and movement of the plant are reflected by the data base in almost real time. Therefore, it is possible to display and output the number of plants and the total price for a newly provided plant, a currently retained plant, a plant in an idle state or a scrapped plant. Moreover, it is also possible to output the area occupied by the plant, a plant retention rate of each department and each cooperative company.

Furthermore, the rest time, the time required for the maintenance work and the required cost in each plant are stored as a history. Therefore, it is possible to calculate and investigate a working rate and a cost of the maintenance for each factory, each manufacturing line, each plant type or each plant.

What is claimed is:

1. A plant management system comprising a terminal device provided in each factory, a server connected to the terminal device through a network, and a data base connected to the server, in which the server provides, to the terminal device, storage of information to the data base and reading of the information of the data base,
wherein information about each plant of each factory and a history of movement of the plant and a history of maintenance are stored in the data base.

2. The plant management system of claim 1, wherein the movement of the plant or the execution of the maintenance is inputted from the terminal device and is stored as the history of the movement or the history of the maintenance in the data base.

3. A plant management system comprising a server connected to a terminal device in each factory through a network and a data base connected to the server,
wherein the server includes plant registering means for storing, in the data base, information about a plant inputted from the terminal device, part registering means for storing, in the data base, information about a part inputted from the terminal device, plant movement managing means for storing, in the data base, information about movement of the plant inputted from the terminal device, maintenance history managing means for storing, in the data base, information about execution of a maintenance work of the plant which is inputted from the terminal device, maintenance planning means for storing, in the data base, a maintenance plan of the plant which is inputted from the terminal device, plant structure registering means for storing a relationship between the plant and a component of the plant which are inputted from the terminal device, part stock managing means for storing, in the data base, information about receipt and discharge of the part inputted from the terminal device, master managing means for changing each master of the data base from the terminal device, term managing means for extracting from the maintenance plan a maintenance plan in which the number of days to an execution date is equal to or less than a predetermined term, mail notifying means for transmitting a guidance mail for maintenance execution to an object plant management department of the extracted maintenance plan, and retrieval reading means for retrieving information in the data base and presenting the information to be readable to the terminal device.

4. The plant management system of claim 3, wherein the term managing means extracts the maintenance plan which has not been executed after the predetermined term passes since the maintenance plan and the mail notifying means transmits a demand mail for the maintenance execution to the object plant management department of the extracted maintenance plan.

5. The plant management system of claim 3, wherein at least any of the plant registering means, the part registering means, the plant movement managing means, the maintenance history managing means, the maintenance planning means, the plant structure registering means and the master managing means has an electronic approving function for acquiring an approval from the terminal device through the network and the information after acquirement of approval is intended for the retrieval reading.

6. The plant management system of claim 3, wherein the plant registering means has a function of outputting a plant number peculiar to a plant as a bar code, and reads the bar code attached to the plant and collates the bar code with the information about the movement of the plant which is stored in the data base, thereby collating actual things of the plant.

7. A plant management system comprising a server connected to the terminal device of each factory through a network and a data base connected to the server,
wherein the data base includes a plant information table storing information about a plant, a plant history table storing a movement history of the plant, a maintenance history table storing a history of maintenance of the plant, a maintenance plan table storing a maintenance plan, a plant structure table storing a relationship between the plant and a plant component, a part information table storing a stock situation of a part in each stockroom, an ordering history table storing an ordering history of a part, and a receipt and discharge history table storing a history for receipt and discharge of the part.
